(19) United States
(12) Patent Application Publication
(10) Pub. No.: US 2002/0172459 A1
(43) Pub. Date: Nov. 21, 2002

(54) Method and apparatus for coupling light into an optical waveguide

(76) Inventors: Timothy J. Bailey, Longmeadow, MA (US); Martin A. Putnam, Cheshire, CT (US); John A. Moon, Wallingford, CT (US); Jay W. Dawson, Livermore, CA (US); Joseph Pinto, Wallingford, CT (US); James S. Sirkis, Wallingford, CT (US); Paul S. Szczepanek, Middletown, CT (US)

Correspondence Address: CiDRA Corporation, 50 Barnes Park North, Wallingford, CT, 06492, US

(21) Appl. No.: 10/098,892

(22) Filed: Mar. 15, 2002

Related U.S. Application Data
(60) Provisional application No. 60/276,453, filed on Mar. 16, 2001.
(60) Provisional application No. 60/276,457, filed on Mar. 16, 2001.

(51) Int. Cl. G02B 6/26; G02B 6/32

(52) U.S. Cl. 385/31; 385/33

(57) ABSTRACT

An optical coupling device is provided for coupling a pump light into an optical waveguide such as an optical fiber or planar waveguide. An optical source provides a pump light. A large diameter optical waveguide is arranged in relation to the optical source, has a diameter substantially greater than 0.3 microns, and includes a reflective surface that reflects the pump light and provides a reflected pump light to the optical fiber. The reflective surface may be either a notched surface of a V-shaped indentation or a cleaved end of the large diameter optical waveguide. Alternatively, the optical coupling device is includes a side tap lens mounted to the large diameter optical waveguide for directing pump light provided by the optical source. The side tap lens is arranged in relation to the optical source and includes a reflective surface that reflects the pump light and provides a reflected pump light to the large diameter waveguide, which directs the pump light to the optical fiber. The reflective surface may include a coated surface to enhance reflectivity.

### CROSS-REFERENCE TO RELATED APPLICATIONS

This application claims the benefit of U.S. Provisional Application No. 60/276,453, filed Mar. 16, 2001, entitled “Method and Apparatus for Coupling Light into an Optical Waveguide”; U.S. Provisional Application No. 60/276,457, filed Mar. 16, 2001, entitled “Method and Apparatus for Coupling Light into an Optical Waveguide”; and U.S. patent application Ser. No. 09/455,868, filed Dec. 6, 1999, entitled “Large Diameter Optical Waveguide, Grating and Laser”, all of which are incorporated herein by reference in their entirety.

### BACKGROUND OF INVENTION

1. Technical Field

The present invention relates to a method and apparatus for coupling light from an optical source into a waveguide; and more particularly to a method and apparatus for coupling pump light into an optical waveguide having a notch device or using a side tap lens for coupling pump light into an optical waveguide.

2. Description of Related Art

The rapid growth of all-optical networks has spurred the need for optical amplifiers. For metro and local area networks in particular, a relatively inexpensive amplifier device is highly desirable. A convenient approach for realizing low cost amplifier devices relies on side pumping of double-clad, rare earth doped fibers. For example, U.S. Pat. No. 5,854,865, issued to Goldberg, the disclosure of which is incorporated herein by reference. Goldberg discloses a technique for coupling pump light into an optical fiber that is typically 125 microns in diameter (Goldberg, column 5, line 1). The optical fiber has a groove through its outer cladding and outer core (or inner cladding), but not its inner core. In operation, a pump laser provides a pump light through the optical fiber (perpendicular to the longitudinal axis of the fiber), where the pump light is reflected off a surface defining the groove into the inner cladding of the optical fiber. The pump light propagates along the optical fiber and eventually gets absorbed into the inner core. However, one disadvantage of Goldberg's arrangement is that it cannot be easily, efficiently or reliably manufactured and is adaptable to only a few specific embodiments and uses. For example, the 125 micron optical fiber is fragile and not easy to handle or notch. Moreover, the manufacture of Goldberg's arrangement may produce a very low yield, which increases the cost of manufacturing the same. Moreover still, the reliability of Goldberg's arrangement may be limited due to its fragile construction.

Another disadvantage of Goldberg's arrangement is that it relies on passing the pump light through the core of the fiber to impinge upon the reflective surface. Further Goldberg relies on a highly reflective surface, which is difficult to achieve on such a small scale.

### SUMMARY OF INVENTION

The present invention provides an optical coupling device for coupling light into an optical waveguide. In accordance with the present invention efficient coupling of light into a large diameter optical waveguide for transmission into an optical fiber. The present invention includes providing light into a notch provided in the side of the waveguide. The notch is designed to provide at least one facet for the light to reflect off and enter the core of the waveguide. In particular embodiments of the present invention optical light in the form of pump light is directed through a micro lens arranged proximate the waveguide is transmitted through the waveguide and impinges upon the facet of the notch. The pump light is reflected off of the facet and enters an inner cladding of the waveguide and is guided along inner cladding and eventually is absorbed into and enters the core. The light then exits the waveguide and is transmitted along an optical fiber. The geometry of waveguide, as well as its composition with regard to dopants, core and cladding configurations and the facets are selected to guide and couple the pump light. The face may be further polished or coated to enhance the reflection characteristics to increase the transmission of pump light.

The waveguide has an outer dimension of at least about 0.3 mm and the core has an outer dimension such that it propagates only a few spatial modes. For example for single spatial mode propagation, the core has a substantially circular transverse cross-sectional shape with a diameter less than about 16.5 microns, depending on the wavelength of light. The invention will also work with larger or non-circular cores that propagate a few spatial modes, in one or more transverse directions. The outer diameter of the cladding and the length have values that will resist bending and buckling when the waveguide is handled or placed in axial compression. Further, the size of the waveguide has inherent mechanical rigidity that improves packaging options and reduces bend losses over that of conventional optical fiber.

The optical source may provide a pump light such as a pump, broad-stripe diode laser or other laser diode that provides the pump light.

The reflective surface may be a notched surface of a V-shaped indentation formed in the large diameter glass waveguide or an angled endface of the large diameter glass waveguide.

The reflective surface may an angle of 45 degrees in relation to the longitudinal axis of the large diameter glass waveguide.

The reflective surface may include a coated surface to enhance reflectivity.

The large diameter glass waveguide has a core surrounded by an inner cladding. The inner cladding may be surrounded by a soft outer clad or protective jacket. The large diameter glass waveguide may have an outer cladding arranged between the inner cladding and the soft outer clad or protective jacket.

The optical coupling device may also include a focusing lens that focuses the pump light on the reflective surface. The focusing lens may comprise v-grooves or other suitable shapes formed within the waveguide. In other embodiments the focusing lens may comprise a cylindrical optical fiber for focusing the pump light at a reflection surface or directing the light into a cladding.

An alternative embodiment of optical coupling device has a large diameter waveguide that includes an L-groove having facets disposed thereon. An optical source is positioned proximate the facets to direct pump light onto the facets. The position of optical source, the angles of the facets and the refractive properties of the outer cladding, inner cladding and core are all selected to reflect pump light into the core.

One advantage of the claimed optical coupling is that it can be much more easily, efficiently and reliably manufactured than the prior art device. For example, the large diameter glass waveguide of the optical coupling device is much easier to handle and notch than the prior art device. Moreover, the manufacture of the optical coupling device produces a substantially higher yield, which decreases the cost of manufacturing the same.

In another embodiment, this optical coupling device is a double-clad fiber amplifier that exploits reflection off a dielectrically-coated interface as a means for coupling pump light into the large diameter glass waveguide. During manufacture, a large diameter waveguide includes an outer cladding, an inner cladding and a core and is approxiamtely 1 millimeter in diameter. An angled reflective end surface is cut and polished at a 45 degree angle on one end of the waveguide and a dichroic film is used as the dielectric coating for achieving high reflection at the pump wavelength of 975 nanometers and anti-reflection at the signal wavelength of 1550 nanometers at a 45 degree angle of incidence. The optical signal is coupled into the fiber amplifier through a single mode fiber that is bonded to the dielectric coating using a thin layer of optical epoxy.

In another embodiment, an optical coupling arrangement has a large diameter glass waveguide having an angled slot for receiving a thin pellicle film having a dielectric material or coating. The angled slot has an angle of about 45 degrees in relation to the longitudinal axis of the large diameter glass waveguide. The dielectric material is a dichroic dielectric coating having a high reflectivity at the pump wavelength and a low reflectivity at the signal wavelength and is applied to the thin pellicle film, which is subsequently inserted into a narrow slot cut through the amplifier.

In still another embodiment a dielectric coating (high reflecting at the pump wavelength to the 45 degree wedge end face, but only in the fiber clad region where the pump light propagates. In this embodiment, the optical signal will propagate through the core without interacting with the dielectric coating, thus eliminating the possibility of polarization dependent loss of the signal wavelength at the dielectric interface. Removal of the dielectric coating from the core region can be achieved by implementing some form of masking (commonly used in photolithography). Another possibility is to use an ablation process (perhaps by coupling a high power laser in the core) to remove the dielectric from the core.

The advantages of these approaches over the V-groove facet technique are simplicity and ease of manufacturability. Moreover, the use of a dielectrically coated end face efficiently couples pump light directly into the clad, eliminating the need for fabricating a v-groove structure. This technique should also be easy to scale to high volume manufacturability.

Another embodiment of the present invention provides an optical coupling device for coupling light into an optical waveguide. In accordance with the present invention efficient coupling of light into a waveguide for transmission into an optical fiber. The present invention includes providing a side tap lens optically coupled to a waveguide. The lens is designed to provide at least one facet for the light to reflect off and enter the core of the waveguide. In particular embodiments of the present invention optical light in the form of pump light is directed through a micro lens arranged proximate the waveguide is transmitted through the waveguide and impinges upon the facet of the lens. The pump light is reflected off of the facet and enters an inner cladding of the waveguide and is guided along inner cladding and eventually is absorbed into and enters the core. The light then exits the waveguide and is transmitted along an optical fiber. The geometry of waveguide, as well as its composition with regard to dopants, core and cladding configurations and the facets are selected to guide and couple the pump light. The facet may be further polished or coated to enhance the reflection characteristics to increase the transmission of pump light.

The foregoing and other objects, features and advantages of the present invention will become more apparent in light of the following detailed description of exemplary embodiments thereof, as illustrated in the accompanying drawing.

### BRIEF DESCRIPTION OF THE DRAWINGS

The drawings include FIGS. 1-23, not drawn to scale, and the following is a brief description thereof:

FIG. 1 is a top view of an embodiment of an optical coupling device that is the subject matter of the present invention.

FIG. 2 is a cross sectional view of the embodiment of FIG. 1 taken substantially along line 2-2 in FIG. 1.

FIG. 3 is a cross sectional view of an embodiment of an optical coupling device that is the subject matter of the present invention.

FIG. 4 is a top view of an embodiment of an optical coupling device that is the subject matter of the present invention.

FIG. 5 is a cross sectional view of the embodiment of FIG. 4 taken substantially along line 5-5 in FIG. 4.

FIG. 6 is a top view of an embodiment of an optical coupling device that is the subject matter of the present invention.

FIG. 7 is a cross sectional view of the embodiment of FIG. 6 taken substantially along line 7-7 in FIG. 6.

FIG. 8 is a cross sectional view of an embodiment of an optical coupling device that is the subject matter of the present invention, including a large diameter glass waveguide having an angled endface.

FIG. 9 is a cross sectional view of an embodiment of an optical coupling device that is the subject matter of the present invention, including a large diameter glass waveguide having an angled endface.

FIG. 10 is a cross sectional view of an embodiment of an optical coupling device that is the subject matter of the present invention, including a large diameter glass waveguide having an angled endface.

FIG. 11 is a cross sectional view of an embodiment of an optical coupling device that is the subject matter of the present invention, including a reflective surface having a dielectric material.

FIG. 12 is a cross sectional view of an embodiment of an optical coupling device that includes multiple devices of FIG. 10 optically arranged in series.

FIG. 13 is a cross sectional view of an embodiment of an optical coupling device that is the subject matter of the present invention, including a large diameter glass waveguide having an angled slot with a dielectric film material arranged therein.

FIG. 14 is a cross sectional view of an embodiment of an optical coupling device that is the subject matter of the present invention, including a large diameter glass waveguide having an optical fiber coupled within a maria formed therein.

FIG. 15 is a side view of an embodiment of a side tap lens that is the subject matter of the present invention coupled to a large diameter waveguide.

FIG. 16 is a cross sectional end view of the embodiment of FIG. 15.

FIG. 17 is a perspective view in partial section cross sectional of a side tap lens that is the subject matter of the present invention coupled to an optical fiber.

FIG. 18 is a side view of the embodiment shown in FIG. 17.

FIG. 19 is a perspective view in partial section cross sectional a side tap lens that is the subject matter of the present invention coupled to an optical fiber.

FIG. 20 is a side view of the embodiment shown in FIG. 19.

FIG. 21 is a side view of the embodiment shown in FIG. 19 coupled to a large diameter waveguide.

FIG. 22 is a cross sectional view of an embodiment of a side tap coupling device that is the subject matter of the present invention coupled to a large diameter glass waveguide.

FIG. 23 is a cross sectional view of the embodiment shown in FIG. 22.

### DETAILED DESCRIPTION OF THE INVENTION

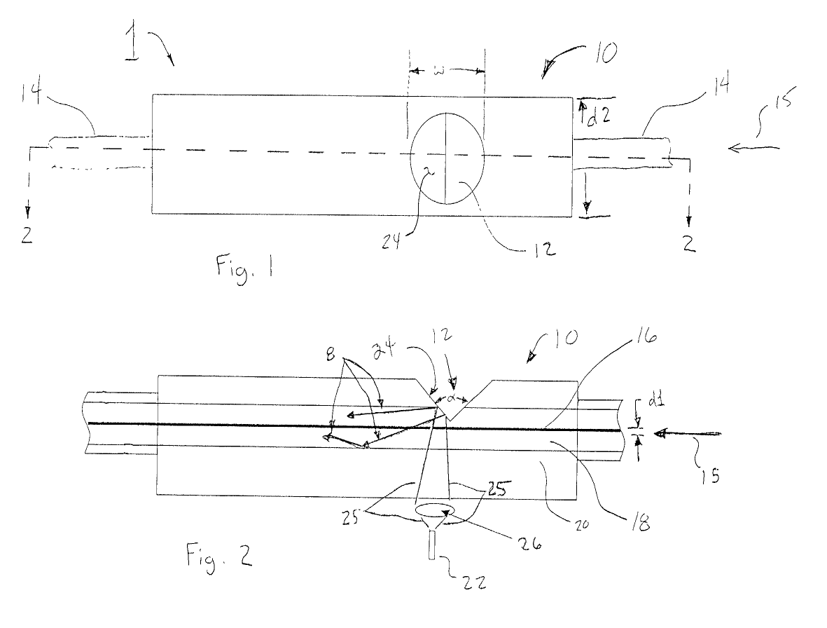

Referring to FIG. 1, a large diameter optical waveguide 10 is shown including a notch arrangement 16 for coupling pump light into an optical waveguide (i.e., an optical 14) as will be more fully described herein below. Referring further to FIG. 2, waveguide 10 has at least one core 16 surrounded by an inner cladding 18, and an optional outer cladding 20 and is similar to that disclosed in co-pending U.S. patent application Ser. No. 09/455,868 entitled “Large Diameter Optical Waveguide, Grating, and Laser”, which is incorporated herein by reference. The waveguide 10 comprises silica glass (SiO₂) based material having the appropriate dopants, as is known, to allow light 15 to propagate in either direction along the core 16 and/or within the waveguide 10. The core 16 has an outer dimension dl and the waveguide 10 has an outer dimension d2. Other materials for the optical waveguide 10 may be used if desired. For example, the waveguide 10 may be made of any glass, e.g., silica, phosphate glass, or other glasses; or solely plastic.

Typically the waveguide 10 is formed to efficiently allow light to propagate along its length with minimal losses through the inner cladding. To this end, it is typical to design a waveguide to have various refractive indices through its cross section. For instance, it is common for the outer cladding 20 to have the lowest refractive index, the core 16 to have the highest refractive index and the inner cladding 18 to have a refractive index somewhat higher than the outer cladding, but lower than the refractive index of the core. Other configurations are possible, including matched indices and depressed inner clad designs, and are contemplated within the scope of the present invention. The present invention takes advantage of the various refractive properties of the waveguide as will be explained more fully herein below.

The waveguide 10 has an outer dimension d2 of at least about 0.3 mm and the core 16 has an outer dimension d1 such that it propagates only a few spatial modes (e.g., less than about 6). For example for single spatial mode propagation, the core 16 has a substantially circular transverse cross-sectional shape with a diameter d1 less than about 16.5 microns, depending on the wavelength of light. The invention will also work with larger or non-circular cores that propagate a few (less than about 6) spatial modes (i.e., single mode), in one or more transverse directions. The outer diameter d2 of the cladding 18 and the length L have values that will resist bending and buckling when the waveguide 10 is handled or placed in axial compression. Further, the size of the waveguide 10 has inherent mechanical rigidity that improves packaging options and reduces bend losses over that of conventional optical fiber.

The waveguide 10 may be made using fiber drawing techniques now known or later developed that provide the resultant desired dimensions for the core and the outer diameter discussed hereinbefore. Because the waveguide 10 has a large outer diameter compared to that of a standard optical fiber (e.g., 125 microns), the waveguide 10 may not need to be coated with a buffer and then stripped to perform subsequent machining operations, thereby requiring less steps than that needed for known fiber based optical coupling configurations. Also, the large outer diameter d2 of the waveguide 10 allows the waveguide to be ground, etched or machined while retaining the mechanical strength of the waveguide 10. Other advantages of the mechanical strength and rigidity of the present invention over the prior art will be explained more fully herein below with reference to specific embodiments. The present invention is easily manufactured and easy to handle. Also, the waveguide 10 may be made in long lengths (on the order of many inches, feet, or meters) then cut to size as needed for the desired application.

The waveguide 10 may have end cross-sectional shapes other than circular, such as square, rectangular, elliptical, clam-shell, octagonal, multi-sided, or any other desired shapes, discussed more hereinafter. Also, the waveguide may resemble a short “block” type or a longer “cane” type geometry, depending on the length of the waveguide and outer dimension of the waveguide.

The dimensions and geometries for any of the embodiments described herein are merely for illustrative purposes and, as such, any other dimensions may be used if desired, depending on the application, size, performance, manufacturing requirements, or other factors, in view of the teachings herein.

The scope of the invention is also intended to include coupling the pump light into other types of optical waveguides such as a planar waveguide. The optical coupling device 1 includes an optical source 22 and a large diameter optical waveguide, generally indicated as 10. The large diameter optical waveguide 10 has a diameter substantially greater than 0.3 mm and is formed using glass technology developed by the assignee of the present invention. The optical coupling device 1 is shown including optical fibers 14 optically connected to waveguide 10 to provide an optical path for light 15 to pass therethrough. The fibers 14 may be attached to waveguide 10 by any known, contemplated or future method without deviating from the scope of the present invention.

The optical source 22 is shown in FIG. 2 as a pump, broad-stripe diode laser or other laser diode that provides the pump light. Pump lights and diodes are known in the art, and the scope of the invention is not intended to be limited to any particular type of light source.

As best shown in FIG. 2 and with reference to FIG. 1, notch 12 is formed in waveguide 10 and projects through outer cladding 20 and into inner cladding 18 without breaching the core 16. Notch 12 defines reflection face 24 for directing the pump light as will be more fully described herein below. The reflection face 24 may be micro machined, etched or otherwise formed in waveguide 10 using known techniques. The face may be further polished or coated to enhance the reflection characteristics to increase the transmission of pump light.

Still referring to FIG. 2, in operation optical light source 22 projects pump light 25 through optional micro lens 26. Pump light 25 passes through waveguide 10 and impinges upon reflection surface 24 of notch 12. The pump light 25 is reflected off of reflection surface 24 and enters inner cladding 18 of waveguide 10 as reflected pump light 28 as depicted by the arrows. Reflected pump light 28 is guided along inner cladding 18 and eventually is absorbed into and enters core 16 whereupon it works to amplify signal light 15 and exits waveguide 10 and is transmitted along fiber 14. The geometry of waveguide 10, as well as its composition with regard to dopants, core and cladding configurations are selected to guide and couple reflected pump light 28.

For embodiments where the reflective surface 24 is not coated, then pump light from the pump diode 25 directed to reflect off the reflective surface 18 should meet certain angular conditions for optimum performance. The pump light 25 must be within a range of angles such that the light impinging on surface 24 is substantially totally reflected. As may be recognized by one skilled in the art a micro lens, such as depicted by 26, may be utilized to achieve the desired angle. Furthermore, upon reflection off of face 24 reflected pump light 28 must reflect into inner cladding 18 in such a way as to be within a range of angles to be substantially totally guided within the inner cladding. Coating of the reflection face 24 allows pump light 25 to impinge upon the face at a wider range of angles. Although the reflective surface 18 is shown as a notched surface of a V-shaped indentation formed in the large diameter optical waveguide 10; however, the scope of the invention is not intended to be limited to only a V-shaped indentation, consistent with that discussed below.

The present invention will now be described with reference to FIGS. 1 and 2 with reference to specific embodiment. In a particular embodiment the outside diameter d2 of the waveguide 10 of optical coupling device 1 was about 0.999 mm and included standard 125 micron fibers 14 pigtailed to the waveguide. Optical source 22 comprised a diode laser having a nominal output power of about 800 mW at a nominal wavelength of 975 nm. The notch 12 had a width w of approximately 39.41 microns and the angle α of the notch was 90 degrees. A glass cutting saw was used that provided reflection face 24 with a rather rough finish. As a result of the finish only about 25% of pump light 25 was coupled into core 16. In another embodiment reflected surface 24 was treated using a commercially available chemical polish wherein approximately 70% of the pump light 25 was coupled into the core 16. Other polishing and treating techniques are contemplated by the present invention for enhancing the coupling of the pump light into the core.

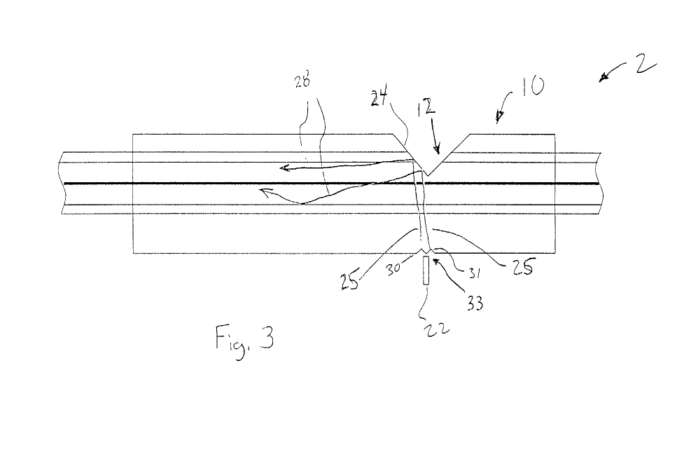

An alternative embodiment of the present invention is best shown with reference to FIG. 3 wherein optical coupling device 2 comprises a waveguide 10, which includes v-grooves 30, 31 machined therein. The facets of the grooves 30, 31 function as a micro lens 33 similar to lens 26 of FIG. 1 to direct pump light 25 at appropriate angles to impinge upon reflection surface 24. The structural characteristics of waveguide 10 as described herein above provide the capability of incorporating micro lens 33 within optical coupling device 2. Micro lens 33 depicted as V-grooves and may have included angles ranging from about 1 to about 90 and may be about 100 microns wide. In the embodiment shown optical light source 22 projects pump light 25 through micro lens 33. Pump light 25 passes through waveguide 10 and impinges upon reflection surface 24 of notch 12 and further enters inner cladding 18 of waveguide 10 as reflected pump light 28 similar to that described herein above. Reflected pump light 28 is similarly guided along inner cladding 18 and eventually is absorbed into and enters core 16. Although depicted as v-grooves, micro lens 33 may comprise any configuration capable of directing pump light 25 onto reflection surface 24.

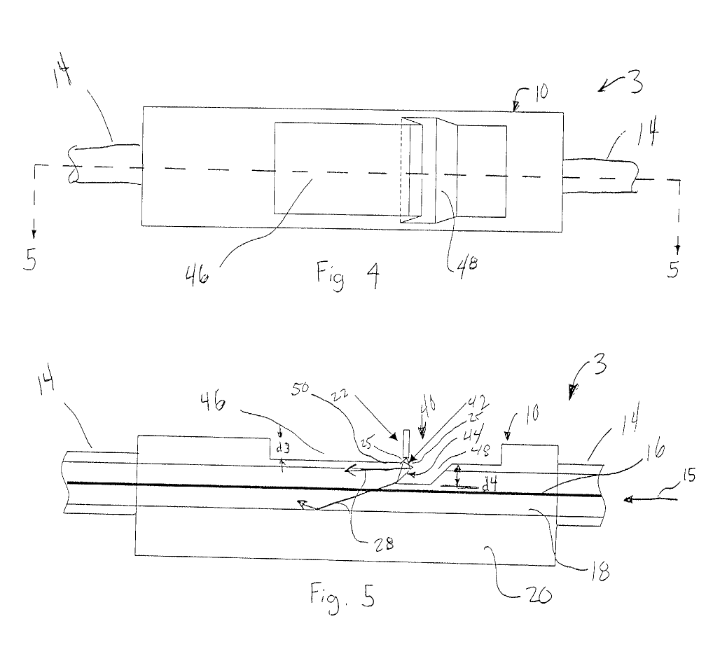

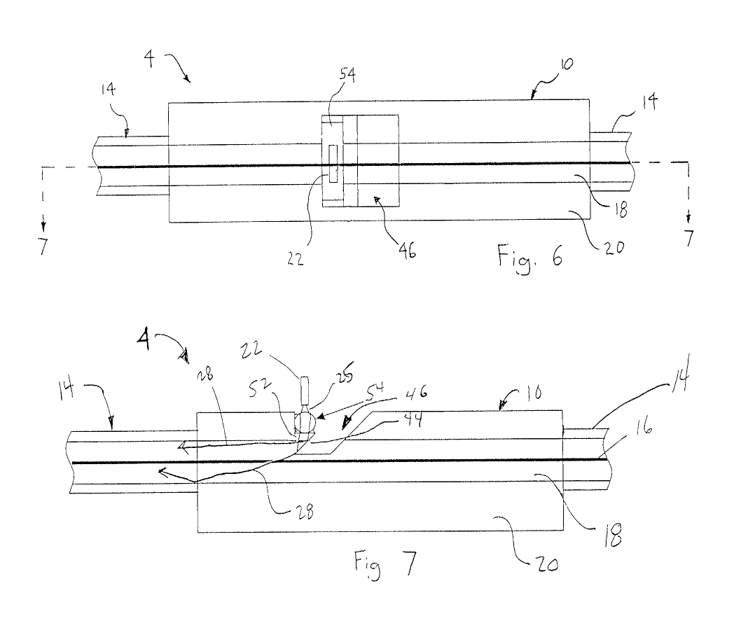

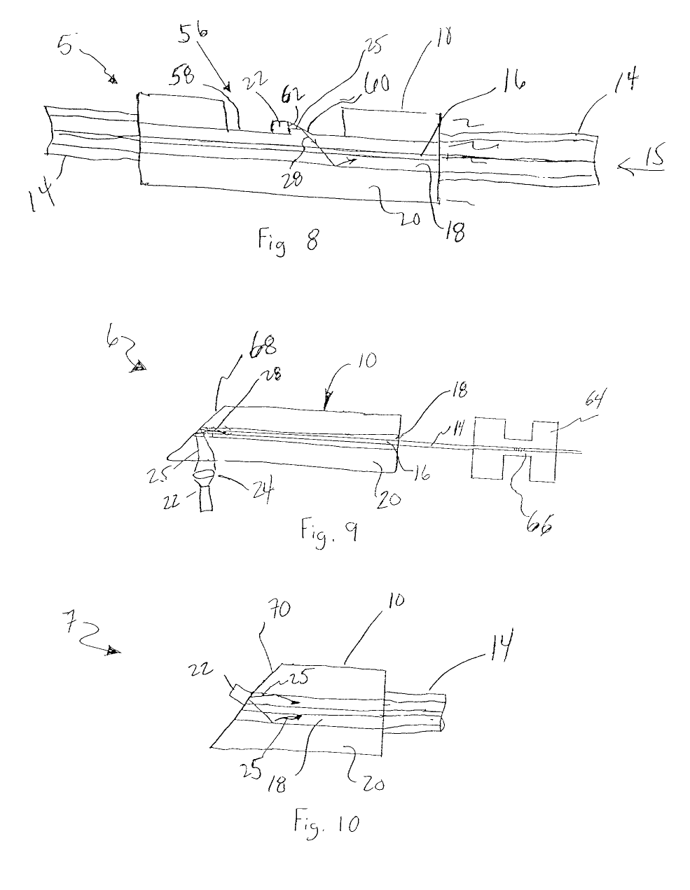

Referring to FIGS. 4 and 5 there is shown an alternative embodiment of optical coupling device 3 including a large diameter waveguide 10, optical fibers 14 and a pump source 22. The waveguide 10 includes an L-groove 40 having facets 42, 44 disposed thereon. Optical source 22 is positioned proximate the facets 42, 44 to direct pump light 25 onto the facets. The position of optical source 22, the angles of the facets and the refractive properties of the outer cladding 20, inner cladding 18 and core 16 are all selected to reflect pump light 25 into the core as can be appreciated by those skilled in the art. In the embodiment shown the waveguide includes a channel 46 disposed in the outer cladding 20 of waveguide 10, an L-groove 40 is comprised of a second channel 48 disposed within channel 46 and transitioning into inner cladding 18, including facet 44, and facet 42 positioned therebetween. The channels and facets are integral to and may be formed in waveguide 10 by micro machining, etching, or other known or contemplated methods. Further, and as described herein before, reflection surface 44 may be polished coated or otherwise treated to provide improve reflection characteristics.

Still referring to FIGS. 4 and 5, in operation optical light source 22 projects pump light 25 directly onto facet 42 and surface 50 of channel 46. A micro lens may be used but is not necessary in this particular embodiment as the pump source may be positioned proximate to the facets. Pump light 25 passes through waveguide 10 and is refracted at various angles and impinges upon facet 44 of channel 48. The pump light 25 is reflected off of facet 44 and enters inner cladding 18 of waveguide 10 as reflected pump light 28 as depicted by the arrows. Reflected pump light 28 is guided along inner cladding 18 and eventually is absorbed into and enters core 16 whereupon it works to amplify signal light 15 and exits waveguide 10 and is transmitted along fiber 14 as described herein before.

It will be appreciated that the embodiment shown in FIGS. 4 and 5 includes advantages over the prior art as outlined herein above. Further the embodiments described have the advantage of directly inputting pump light 25 into the inner cladding and core without having to first cross the path of source light 15. In one particular embodiment of the invention shown in FIGS. 4 and 5 waveguide 10 comprised an outer diameter d1 of about 2.0 mm, channel 46 had a channel depth d3 of about 1000 microns and channel 48 had a depth of about 50 to 100 microns. Further facet 44 was formed at an angle of about 45 degrees relative to channel 48. Similarly facet 42 was formed at an angle of about 30-45 from surface 50.

The present invention further comprises an optical coupling device 4 which includes an L-groove configuration including a micro lens as best shown with reference to FIGS. 6 and 7 wherein waveguide 10 is similar to that described herein before. L-groove 46 is disposed within the outer cladding 20 and extends partially through the inner cladding 18. Similar to that described herein above L-groove 46 comprises reflection surface 44 and further includes ledge 52 positioned therein to support micro lens 54. Although various embodiments exist, micro lens 54 is depicted in FIGS. 6 and 7 as a 125 micron optical fiber. The micro lens 54 may be coupled to the L-groove 46 and/or the ledge 52 by a suitable adhesive, such as epoxy, or any other known or contemplated method.

In the optical coupling device 4 of FIGS. 6 and 7 optical light source 22 projects pump light 25 into micro lens 54 and in turn impinges on reflection surface 44. Given the cylindrical nature of micro lens 54 pump light 25 passes through the micro lens and into waveguide 10 at various predictable refracted angles and impinges upon facet 44. The pump light 25 is reflected off of facet 44 and enters inner cladding 18 of waveguide 10 as reflected pump light 28 as depicted by the arrows. Reflected pump light 28 is guided along inner cladding 18 and eventually is absorbed into and enters core 16 whereupon it works to amplify signal light 15 and exits waveguide 10 and is transmitted along fiber 14 as described herein before.

FIG. 8 shows another embodiment of an optical coupling device generally indicated as 5, for coupling a pump light 25 into an optical fiber 14 coupled to the large diameter waveguide 10. The optical coupling device 5 includes an optical source 22 and a large diameter optical waveguide 10. Similar to that discussed above, the optical source 22 is shown as a pump light or laser diode that provides the pump light 25.

In FIG. 8, the large diameter optical waveguide 10 has a core 16, an inner cladding 18 and an outer cladding 20. The large diameter optical waveguide 10 has a notch disposed therein generally indicated as 56 formed as a channel with a channel surface 58, a raised and angled reflection face 60 and a perpendicular face 62 normal to the channel surface 58. As shown, the optical source 22 is arranged on the channel surface 58 for providing the pump light through the perpendicular face 62 for reflecting off the raised and angled reflection face 60 towards the inner cladding 18. The optical light source 22 projects pump light 25 directly into the outer cladding portion 20 of waveguide 10 where it impinges upon reflection face 60. A micro lens may be used but is not necessary in this particular embodiment as the pump source may be positioned proximate the reflection face. The pump light 25 is reflected off of reflection face 60 and enters inner cladding 18 of waveguide 10 as reflected pump light 28. Reflected pump light 28 is guided along inner cladding 18 and eventually is absorbed into and enters core 16 whereupon it works to amplify signal light 15 and exits waveguide 10 and is transmitted along fiber 14 as described herein before. This particular embodiment also has the advantage of directly inputting pump light 25 into the inner cladding and core without having to first cross the path of source light 15.

FIG. 9 shows another embodiment of an optical coupling device generally indicated as 6, for coupling a pump light into an optical fiber 14 connected to an optical device 64 having one or more gratings 66 embedded therein. The optical device 64 may comprise a dogbone element as disclosed in Applicants copending U.S. Patent Application serial number CC-066A, incorporated herein by reference, so as to form a laser or other optical device. The optical coupling device 6 includes an optical source 22 and a large diameter optical waveguide 10. Similar to that discussed above, the optical source 22 is shown as a pump light or diode that provides the pump light and may further include an optional micro lens 24.

In FIG. 9, the large diameter optical waveguide 10 has an inner core 16, an inner cladding 18 and an outer cladding 20. As shown, the reflective surface 68 is the endface optical waveguide 10. Reflective surface 68 may be formed by cleaving, machining, grinding or other known methods. The optical light source 22 projects pump light 25 through waveguide 10 where it impinges upon reflection face 68. The pump light 25 is reflected off of reflection face 68 and enters inner cladding 18 of waveguide 10 as reflected pump light 28. Reflected pump light 28 is guided along inner cladding 18 and eventually is absorbed into and enters core 16 and exits waveguide 10 and is transmitted along fiber 14 as described herein before. The reflected pump light 28 may combine with source light or be transmitted alone for any contemplated use.

FIG. 10 shows another embodiment of an optical coupling device generally indicated as 7, for coupling a pump light into an optical fiber 14. The optical coupling device 7 includes an optical source 22 and a large diameter optical waveguide 10. Similar to that discussed above, the optical source 22 is shown as a pump light or laser diode that provides the pump light.

In FIG. 10, the waveguide 10 has a core 16, an inner cladding 18 and an outer cladding 20. As shown, the optical source 22 is arranged proximate angled endface 70 for providing the pump light through the endface 70 towards core 16 and inner cladding 18 for absorption into the core. The optical light source 22 projects pump light 25 through outer cladding 20 of waveguide 10 where enters inner cladding 18 of the waveguide. Pump light 25 is guided along inner cladding 18 and eventually is absorbed into and enters core 16 and exits waveguide 10 and is transmitted along fiber 14 as described herein before. The reflected pump light 28 may combine with source light or be transmitted alone for any contemplated use.

Endface 70 may be formed by cleaving, machining, grinding or other known methods The angle of the endface 70 is determined similar to the angle of reflection faces as discussed above for coupling the pump light into the core.

FIG. 11 shows another embodiment of an optical coupling device generally indicated as 8, for coupling a pump light into an optical fiber 14. The optical coupling device 8 includes an optical source 22 and a large diameter optical waveguide 10. Similar to that discussed above, the optical source 22 is shown as a pump light or laser diode that provides the pump light.

In FIG. 11, the waveguide 10 has a core 16, an inner cladding 18 and an outer cladding 20. As shown, the optical source 22 is arranged for providing the pump light 25 through the outer cladding 20 and inner cladding 18 where it impinges upon angled surface 72. Surface 72 is positioned at an angle indicated by 74 of about 45 degrees relative to the longitudinal axis of waveguide 10 and includes a transmission fiber 76 attached thereto. Surface 72 further includes a dielectric coating 77 which when placed at 45 degrees to pump light 25 will provide a high reflectivity for reflecting the pump light (e.g. 975 nm wavelength) onto the core 16 as reflected pump light 28 for absorption into the core. The dielectric coating 77 further provides antireflection at the 45 degree angle and wavelength of the source light 15 (e.g. 1550 nm wavelength). The reflected pump light 28 combines with source light and is transmitted along the fiber 14. In the embodiment 8 the waveguide outside diameter d1 is about 1 mm. Surface 72 may be formed by cleaving, machining, grinding or other known methods

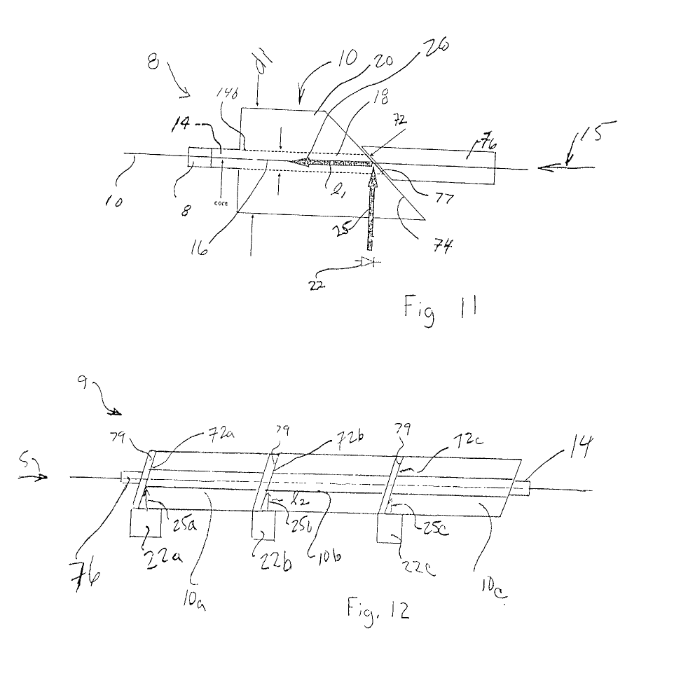

FIG. 12 shows another embodiment of an optical coupling device generally indicated as 9 that includes three large diameter wave guides 10a, 10b, 10c similar to the device 8 of FIG. 11. Each of the three angled surfaces 72a, 72b, 72c include dielectric coatings 79 arranged thereon. The device 9 includes three pump diodes 22a, 22b, 22c for respectively reflecting pump light 25a, 25b, 25c off the angled reflective surfaces 72a, 72b, 72c

Similar to the device 8 of FIG. 11, the pump light 25a, 25b, 25c is used to amplify an optical source signal 15 transmitted along the optical fiber 76 that is optically coupled to waveguide 10a. The amplified signal is transmitted to optical fiber 14 optically connected to waveguide 10c.

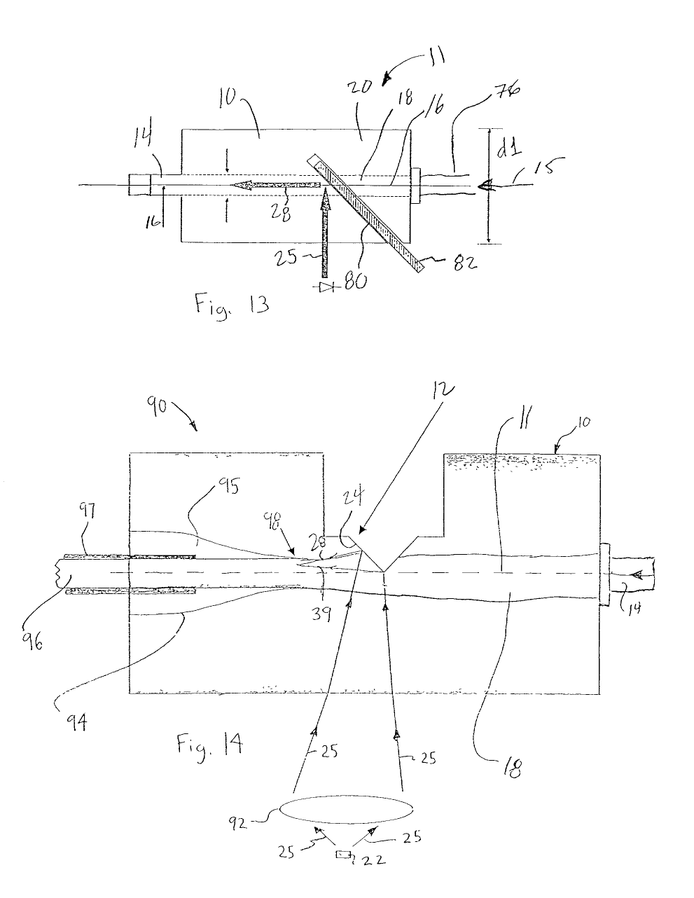

FIG. 13 shows yet another embodiment of an optical coupling device generally indicated as 11 that includes another possible means for coupling pump light 25, or other light, into the a fiber 14. In this embodiment, a large diameter optical waveguide 10 has an angled slot 80 for receiving a thin pellicle film having a dielectric material, together generally indicated as 82. Such dielectric materials or coatings are known in the art, and may consist of a substrate having alternating layers of quarter-wave film of a higher refractive index and lower refractive index than the substrate. Such coatings can be made very specific to a reflected wavelength or, by varying the thickness of the layers or film indexes, spread over a wide wavelength interval. The scope of the invention is not intended to be limited to any particular dielectric material or coating. The film 82 is a dichroic dielectric having a high reflectivity at the pump wavelength and a low reflectivity at the signal wavelength and is applied to the thin pellicle film, which is subsequently inserted into the angled slot 80. As shown, the angled slot 80 has an angle of about 45 degrees in relation to the longitudinal axis of the large diameter optical waveguide 10. Embodiments of the invention are envisioned using other angles.

In FIG. 13, the waveguide 10 has a core 16, an inner cladding 18 and an outer cladding 20. As shown, the optical source 22 is arranged for providing the pump light 25 through the outer cladding 20 and inner cladding 18 where it impinges upon angled film 82. Film 82, as discussed herein above, includes a dielectric coating which when placed at 45 degrees to pump light 25 will provide a high reflectivity for reflecting the pump light (e.g. 975 nm wavelength) onto the core 16 as reflected pump light 28 for absorption into the core. The film 82 further provides antireflection at the 45 degree angle and wavelength of the source light 15 (e.g. 1550 nm wavelength). The reflected pump light 28 combines with source light 15 and is transmitted along the fiber 14. In the embodiment 11 the waveguide outside diameter d1 is about 1 mm. Slot 80 may be formed by machining, grinding or other known methods

FIG. 14 shows another embodiment of an optical coupling device generally indicated as 90, which includes a large diameter optical waveguide 10 arranged in relation to a pump diode 22, and includes a notch 12 having a reflective surface 24. Notch 12 is formed in waveguide 10 and projects through outer cladding 20 and into inner cladding 18 without breaching the core 16. Notch 12 defines reflection face 24 for directing the pump light as will be more fully described herein below. The reflection face 24 may be micro machined, etched or otherwise formed in waveguide 10 using known techniques. The face may be further polished or coated to enhance the reflection characteristics to increase the transmission of pump light.

The optical coupling arrangement 90 includes a focusing lens 92 that responds to the pump light from the pump diode 22, for providing a focused pump light on the reflective surface 24.

As shown, the optical fiber 14 may be fused, epoxied or other means of optically connecting the fiber 14 to the large diameter optical waveguide 10. Waveguide 10 further includes maria 94 arranged along is longitudinal axis in relation to the core 16 and provides an air/cladding interface 95. Optically connected to the waveguide and within maria 94 is optical fiber 96, which includes a polymer outer clad 97. In operation, the optical light 25 from the pump diode 22 is reflected off the reflective surface 24, which provides a reflected pump light 28 to the optical fiber 96. The focusing lens 92 is arranged in relation to the large diameter optical waveguide 10 so that the focused pump light 25 is reflected off the reflective surface 24 such that the reflected pump light 28 is focused at a focus point 98 that lies at the air/glass boundary interface.

As discussed above, the pump light may be used to amplify an optical signal 15 transmitted along optical fiber 14 that passes through the large diameter optical waveguide 114 to the optical fiber 96, or may be used to pump light into an optical waveguide, such as the optical fiber 96. The maria 94 may be formed by grinding, etching, machining or other known techniques or formed during the glass making process for the waveguide 10.

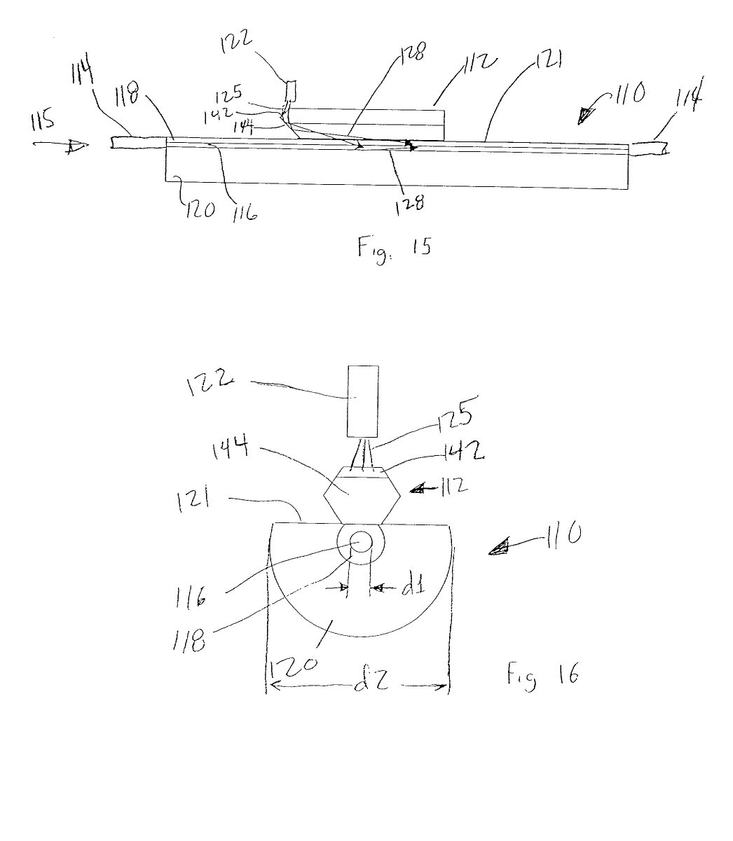

Referring to FIG. 15, a large diameter optical waveguide 110 is shown including a side tap lens 112 for coupling pump light into an optical waveguide 114 as will be more fully described herein below. Referring further to FIG. 16, waveguide 10 has at least one core 116 surrounded by an inner cladding 118, and an optional outer cladding 120 and is similar to that disclosed in co-pending U.S. patent application Ser. No. 09/455,868 entitled “Large Diameter Optical Waveguide, Grating, and Laser”, which is incorporated herein by reference, as described hereinbefore in FIG. 1.

Referring again to FIG. 15, the scope of the invention is intended to include coupling the pump light into other types of optical waveguides such as a planar waveguide. The optical coupling device 101 includes an optical source 122, a side tap lens 112 and a large diameter optical waveguide 110. The large diameter optical waveguide 110 has a diameter greater than 0.3 mm and is formed using glass technology developed by the assignee of the present invention. The optical coupling device 101 is shown including optical fibers 114 optically connected to waveguide 110 to provide an optical path for light 115 to pass therethrough. The fibers 114 may be attached to waveguide 110 by any known, contemplated or future method without deviating from the scope of the present invention.

The optical source 122 is shown in FIG. 15 as a pump, broad-stripe diode laser or other laser diode that provides the pump light. Pump lights and diodes are known in the art, and the scope of the invention is not intended to be limited to any particular type of light source.

As best shown in FIG. 16 and with reference to FIG. 15, waveguide 110 is formed from a cylindrical waveguide wherein all of the outer cladding 120 and a portion of the inner cladding 118 is removed to form surface 121. Surface 121 forms a suitable mounting condition for attaching side tap lens 112 to waveguide as will be described more fully herein after. Surface 121 may be micro machined, ground, etched or otherwise formed in waveguide 110 using known techniques. The face may be further polished or coated to enhance the optical characteristics to increase the transmission of pump light. Surface 121 is also positioned proximate inner cladding 118 to allow for the efficient transmission of pump light 125 as will be more fully explained herein after.

Alternatively, the D-shaped optical waveguide, as shown in FIGS. 15 and 16 may be formed by drawing the waveguide from a D-shaped preform, as described in U.S. Patent Application No. (Cidra No. CC-0230A), which is incorporated herein by reference. An inner preform may be formed using known methods such as multiple chemical vapor deposition (MCVD), outside vapor-phase deposition (OVD) or vapor-phase axial deposition (VAD) processes to form the core, inner cladding and a portion of the outer cladding having the desired composition of material and dopants. One method of manufacturing the preform is described in U.S. Pat. No. 4,217,027 entitled, “Optical Fiber Fabrication and Resulting Product”, which is incorporated herein by reference. A glass tube may then be collapsed onto the inner preform to provide the desired outer diameter of the outer cladding of the preform. After the cylindrical preform is formed, the preform is ground, machined or otherwise formed into a D-shape. The preform is then heated and drawn using known techniques to form the D-shaped waveguide having the desired dimensions as described hereinbefore. During the heating and drawing process, the preform is heated to a predetermined temperature to draw the waveguide, but sufficiently cool so that the waveguide maintains the D-shape. The advantage of drawing the D-shaped waveguide is that the flat surface 121 is fired smooth to provide a clean interface between the side tap lens and the D-shaped waveguide.

Referring again to FIGS. 15 and 16, side tap lens 112 is comprised of a hexagonal fiber having facets 142, 144 disposed thereon. It is advantageous if side tap lens 112 has an index closely matching that of the inner cladding 118 of waveguide 110. Optical source 122 is positioned proximate the facets 142, 144 to direct pump light 125 onto the facet 142. The position of optical source 122, the angles of the facets and the refractive properties of the outer cladding 120, inner cladding 118 and core 116 are all selected to reflect pump light 125 into the core as can be appreciated by those skilled in the art. In the embodiment side tap lens 112 is shown as a commercially available hexagonal optical fiber having an outside dimension of about 200 microns. Other shaped fibers, especially multi-sided fibers, may be employed without departing from the scope of the present invention. Side tap lens 112 is fixedly attached to waveguide 110 by use of an optical quality adhesive, such as an epoxy, although other methods are contemplated such as fusion, solder (powder, liquid or solid), a liquid silica compound, and chemical bonding. An advantage to using a hexagonal fiber is the commercial availability and inherent stability of surface 113 for mounting side tap lens 112 to waveguide 110. Another advantage of utilizing such a fiber for side tap lens 112 is the ease and accuracy with which facets 142, 144 may be formed and subsequently polished and/or coated to provide enhanced optical quality over the prior art. The facets 142, 144 are integral to and may be formed in side tap lens 112 by micro machining, etching, or other known or contemplated methods. Further, and as described herein before, facet or reflection surface 144 may be polished coated or otherwise treated to provide improve reflection characteristics.

In operation optical light source 122 projects pump light 125 directly onto facet 142 of side tap lens 112. A micro lens, as will be described herein after, may be used but is not necessary in this particular embodiment as the pump source may be positioned proximate to the facets. Pump light 125 passes through facet 142 and impinges upon facet 144 and is refracted at various angles. The pump light 125 that is reflected off of facet 144 enters inner cladding 118 of waveguide 110 as reflected pump light 128 as depicted by the arrows. Reflected pump light 128 is guided along inner cladding 118 and eventually is absorbed into and enters core 116 whereupon it works to amplify signal light 115 and exits waveguide 110 and is transmitted along fiber 114. To improve the coupling efficiency side tap lens 112 should be short enough in length to preclude reflected pump light from coupling back into the lens. In addition waveguide 110 may be coated to further preclude reflected pump light 128 from reflecting out of inner cladding 118.

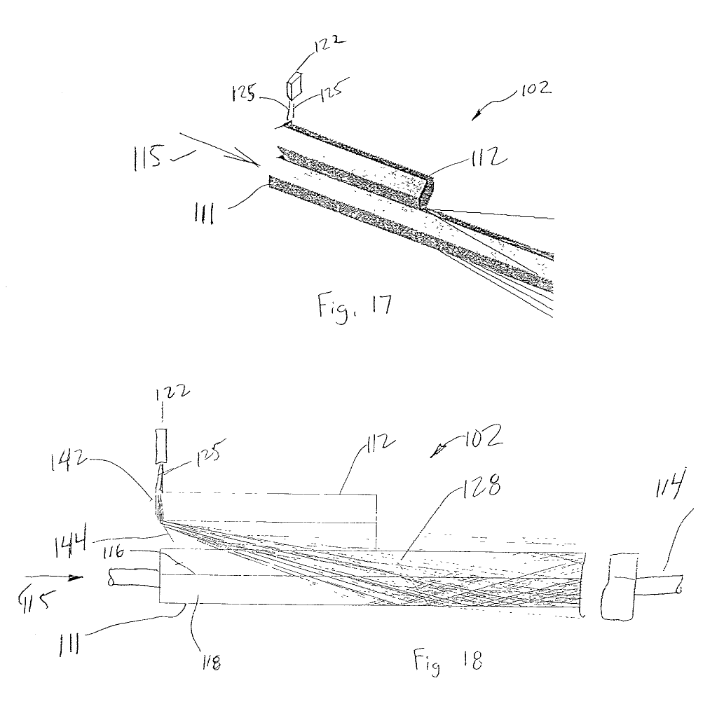

An alternative embodiment of the present invention is best shown with reference to FIGS. 17 and 18 wherein optical coupling device 102 comprises a multisided large diameter waveguide 111 and a side tap lens 112. Multisided large diameter waveguide 111 is shown as a hexagonal waveguide of a similar type, size and characteristics as that described with respect to cylindrical large diameter waveguide of device 1 shown in FIG. 1 also comprising a core 116, inner cladding 118 and outer cladding 120. Side tap lens 112 is comprised of a hexagonal fiber having facets 142, 144 disposed thereon. Optical source 122 is positioned proximate the facets 142, 144 to direct pump light 125 onto the facet 142. The position of optical source 122, the angles of the facets and the refractive properties of the inner cladding 118 and core 116 are selected to reflect pump light 125 into the core as can be appreciated by those skilled in the art. Side tap lens 112 is fixedly attached in axial alignment to waveguide 111 by use of an optical quality adhesive, such as an epoxy, although other methods are contemplated such as fusion, solder (powder, liquid or solid), a liquid silica compound, and chemical bonding. To improve the coupling efficiency side tap lens 112 should be short enough in length to preclude reflected pump light from coupling back into the lens. In addition waveguide 111 may be coated to further preclude reflected pump light 128 from reflecting out of inner cladding 118.

As described herein before, optical light source 122 projects pump light 125 directly onto facet 142 of side tap lens 112. Pump light 125 passes through facet 142 and impinges upon facet 144 and is refracted at various angles. The pump light 125 that is reflected off of facet 144 enters inner cladding 118 of waveguide 111 as reflected pump light 128 as depicted by the simulated ray pattern. Reflected pump light 128 is guided along inner cladding 118 and eventually is absorbed into and enters core 116 whereupon it works to amplify signal light 115 and exits multisided waveguide 111 and is transmitted along fiber 114. In addition to the advantages described for device 1 of FIG. 1, the device 102 of FIGS. 17 and 18 by virtue of the use of a multisided waveguide reduces machining, material cost and facilitates attachment of fibers 114.

The present invention will now be described with reference to FIGS. 17 and 18 with reference to specific embodiment. In a particular embodiment the outside diameter d2 of the waveguide 111 is greater than 0.3 microns and included standard 125 micron fibers 114 pigtailed to the waveguide. Optical source 122 comprised a diode laser having a nominal output power of about 800 mW at a nominal wavelength of 975 nm. The side tap lens comprised a hexagonal optical fiber 112 with a diameter of 200 microns and facets 142, 144 were polished to provide high optical transmission/reflection qualities. As a result about 22.5% of pump light 125 was coupled into core 116. Other polishing and treating techniques are contemplated by the present invention for enhancing the coupling of the pump light into the core.

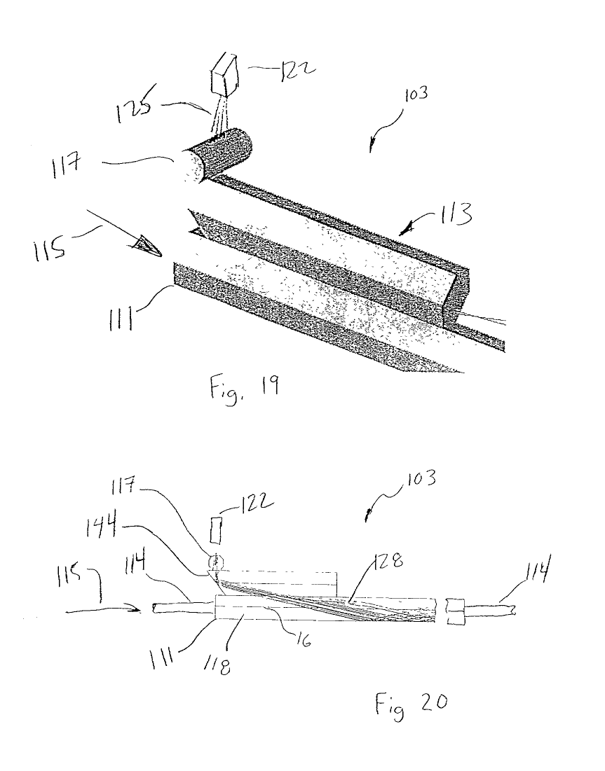

Another alternative embodiment of the present invention is best shown with reference to FIGS. 19 and 20 wherein optical coupling device 103 comprises a multisided waveguide 111, a side tap lens 113 and a micro lens 117. Multisided waveguide 111 is shown as a hexagonal waveguide of a similar type, size and characteristics as that described with respect to multisided waveguide 111 of device 102 shown in FIGS. 17 and 18. Similarly, side tap lens 113 is shown as a hexagonal fiber of a similar type, size and characteristics as that described with respect to side tap lens 12 of device 1 in FIG. 1 and comprises a single reflection face 144 disposed thereon. Although various embodiments exist, micro lens 117 is depicted in FIGS. 19 and 20 as a 125 micron optical fiber. The micro lens 117 may be coupled to the side tap lens 113 by a suitable adhesive, such as epoxy, or any other known or similar method contemplated for attachment of the side tap lens 113 to waveguide 111. In the optical coupling device 103 optical light source 122 projects pump light 125 into micro lens 117 and in turn impinges on reflection surface 144. Given the cylindrical nature of micro lens 117 pump light 125 passes through the micro lens and into side tap lens 113 at various predictable refracted angles and impinges upon facet 144. The pump light 125 is reflected off of facet 144 and enters inner cladding 118 of waveguide 111 as reflected pump light 128 as depicted by the ray pattern. Reflected pump light 128 is guided along inner cladding 118 and eventually is absorbed into and enters core 116 whereupon it works to amplify signal light 115 and exits waveguide 111 and is transmitted along fiber 114 as described herein before.

Cleaving, machining, grinding or other known methods may form the various facets and reflection surfaces of the present invention in the various embodiments discussed herein. The angles, as discussed herein above, are typically formed at a 45-55 degree angle relative to the axial direction of the core. A typical wavelength of the source light 115 is about 1550 nm although other wavelengths are contemplated within the scope of the present invention. The reflected pump light 128 combines with source light and is transmitted along the fiber 114.

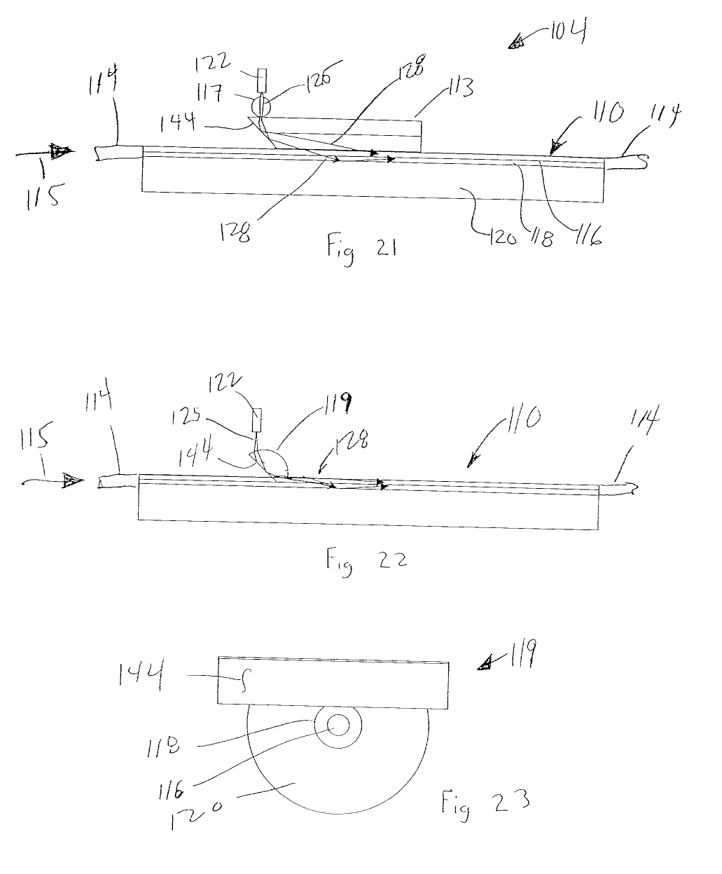

FIG. 21 shows yet another embodiment of an optical coupling device generally indicated as 104 that combines the side tap lens 113 and micro lens 117 of device 103 of FIG. 19 with the large diameter waveguide 110 of FIG. 15.

Yet another embodiment is shown in FIGS. 22 and 23 wherein the side tap lens 119 further includes a reflective face 144 integrally positioned therein. It is contemplated that side tap lens 119 comprise a large diameter waveguide as described herein above and that reflective face 119 is provided in the waveguide by such methods as are described for providing surface 21 of device 1 as shown in FIG. 16. In addition, mounting surface 123 is formed in side tap lens 119 in a similar manner and is mated with surface 121 and joined by any of the methods described herein above.

It should be understood that any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein and thereto without departing from the spirit and scope of the present invention.

What is claimed is:

1. An optical coupling device for coupling a light into an output optical waveguide; the optical coupling device comprising:
a first optical waveguide including an outer cladding having a core disposed therein, the first waveguide having a transverse dimension and a longitudinal dimension, wherein the transverse dimension of the first waveguide is greater than 0.3 mm; and
wherein the first waveguide includes at least one reflective surface positioned to direct light into the core.

2. The optical coupling device of claim 1, wherein said core has a transverse dimension of less than about 12.5 microns.

3. The optical coupling device of claim 1, wherein said core propagates light in substantially a single spatial mode.

4. The optical coupling device of claim 1, wherein the longitudinal dimension of the first waveguide is greater than 3 mm.

5. The optical coupling device of claim 1, wherein at least a portion of said first waveguide has a cylindrical shape.

6. The optical coupling device of claim 1, wherein said core comprises a circular cross-sectional shape.

7. The optical coupling device of claim 1, wherein said core comprises an asymmetrical cross-sectional shape.

8. The optical coupling device of claim 1, wherein the first waveguide includes a groove within the outer cladding, wherein the reflective surface defines a portion of the groove.

9. The optical coupling device of claim 1, further includes an optical lens for focusing the light onto the reflective surface of the first waveguide.

10. The optical coupling device of claim 1, wherein the first waveguide further includes an inner cladding disposed within the outer cladding, and the core is disposed within the inner cladding.

11. The optical coupling device of claim 10, wherein the index of reflection of the inner cladding is greater that the index of refraction of the outer cladding, and less than the index of refraction of the core.

12. The optical coupling device of claim 10, wherein the first waveguide includes a V-shaped groove disposed in the inner and outer cladding.

13. The optical coupling device of claim 1, wherein the output waveguide is an optical fiber optically connected to an output end of the optical waveguide for receiving the light from the first waveguide.

14. The optical coupling device of claim 1 further includes an input optical waveguide optically connected to an input end of the first waveguide for providing a second light to the core of the first waveguide.

15. The optical coupling device of claim 1, wherein the first waveguide includes at least one second groove disposed in the outer cladding to focus the light entering the first waveguide onto the reflective surface.

16. The optical coupling device of claim 1, wherein the first waveguide includes a facet for focusing the light onto the reflective surface.

17. The optical coupling device of claim 1, wherein the lens comprises a cylindrical lens.

18. The optical coupling device of claim 17, wherein the cylindrical lens comprises an optical fiber.

19. The optical coupling device of claim 1, wherein the reflective surface is coated with a reflective coating.

20. The optical coupling device of claim 1, wherein the reflective surface is disposed at an end surface of the optical waveguide.

21. The optical coupling device of claim 1 further includes a light source positioned to reflect light off the reflective surface and into the core.

22. The optical coupling device of claim 1 further includes a light source positioned to refract the light off the reflective surface and into the core.

23. The optical coupling device of claim 1, further includes a reflective film disposed with the optical waveguide adjacent the reflective surface.

24. The optical coupling device of claim 1, wherein at least a portion of the first waveguide has a cylindrical shape.

25. The optical coupling device of claim 1, wherein said core comprises a circular end cross-sectional shape.

26. The optical coupling device of claim 1, wherein said core comprises an asymmetrical cross-sectional shape.

27. The optical coupling device of claim 1, wherein the transverse dimension of the first waveguide is a predetermined value, said value being about 0.3 mm, 0.4 mm, 0.5 mm, 0.6 mm, 0.7 mm, 0.8 mm, 0.9 mm, 1.0 mm, 1.2 mm, 1.4 mm, 1.6 mm, 1.8 mm, 2.0 mm, 2.1 mm, 2.3 mm, 2.5 mm, 2.7 mm, 2.9 mm, 3.0 mm, 3.3 mm, 3.6 mm, 3.9 mm, 4.0 mm, 4.2 mm, 4.5 mm, 4.7 mm, or 5.0 mm.

28. The optical coupling device of claim 1, wherein said length of the first waveguide is a predetermined value, said value being about 3 mm, 5 mm, 7 mm, 9 mm, 10 mm, 12 mm, 14 mm, 16 mm, 18 mm, 20 mm, 21 mm, 23 mm, 25 mm, 27 mm, 29 mm, 30 mm, 32 mm, 34 mm, 36 mm, 38 mm, 40 mm, 45 mm, 50 mm, 55 mm, 60 mm, 65 mm, 70 mm, 75 mm, 80 mm, 85 mm, 90 mm, 95 mm, or 100 mm.

29. The optical coupling device of claim 1, wherein said outer dimension of the first waveguide is greater than a predetermined value, said value being about 0.3 mm, 0.4 mm, 0.5 mm, 0.6 mm, 0.7 mm, 0.8 mm, 0.9 mm, 1.0 mm, 1.2 mm, 1.4 mm, 1.6 mm, 1.8 mm, 2.0 mm, 2.1 mm, 2.3 mm, 2.5 mm, 2.7 mm, 2.9 mm, 3.0 mm, 3.3 mm, 3.6 mm, 3.9 mm, 4.0 mm, 4.2 mm, 4.5 mm, 4.7 mm, or 5.0 mm.

30. The optical coupling device of claim 1, wherein said length of the first waveguide is greater than a predetermined value, said value being about 3 mm, 5 mm, 7 mm, 9 mm, 10 mm, 12 mm, 14 mm, 16 mm, 18 mm, 20 mm, 21 mm, 23 mm, 25 mm, 27 mm, 29 mm, 30 mm, 32 mm, 34 mm, 36 mm, 38 mm, 40 mm, 45 mm, 50 mm, 55 mm, 60 mm, 65 mm, 70 mm, 75 mm, 80 mm, 85 mm, 90 mm, 95 mm, or 100 mm.

31. The optical coupling device of claim 8, wherein the groove is generally V-shaped.

32. The optical coupling device of claim 8, wherein the groove is generally L-shaped.

33. An optical coupling device for coupling a light into an output optical waveguide; the optical coupling device comprising:
a first optical waveguide including an outer cladding having a core disposed therein, the first waveguide having a transverse dimension and a longitudinal dimension, wherein the transverse dimension of the first waveguide is greater than 0.3 mm; and
a side tap lens optically coupled to the first waveguide, wherein at least one reflective surface defined on the side tap lens is positioned to direct the light into the core.

34. The optical coupling device of claim 33, wherein the side tap lens comprises an optical fiber.

35. The optical coupling device of claim 33, wherein the side tap lens comprises a hexagonal optical fiber.

36. The optical coupling device of claim 33, wherein the side tap lens includes a reflective surface for reflecting the light into the core of the first waveguide.

37. The optical coupling device of claim 33, wherein the side tap lens includes a second surface for focusing the light onto the reflective surface.

38. The optical coupling device of claim 33, further includes a focusing lens for directing the light onto the reflective surface.

39. The optical coupling device of claim 38, wherein the focusing lens is an optical fiber.

40. The optical coupling device of claim 33, further includes an optical source that generates the light.

41. The optical coupling device of claim 33, wherein the first waveguide further includes an inner cladding disposed within the outer cladding, and the core is disposed within the inner cladding.

42. The optical coupling device of claim 41, wherein the index of reflection of the inner cladding is greater that the index of refraction of the outer cladding, and less than the index of refraction of the core.

43. The optical coupling device of claim 33, wherein a portion of the first optical waveguide has a substantially flat surface.

44. The optical coupling device of claim 33, wherein a portion of the first optical waveguide has a cross-sectional geometry having a generally D-shape.

45. The optical coupling device of claim 33, wherein a portion of the first optical waveguide has a cross-sectional geometry having a generally hexagonal shape.

46. The optical coupling device of claim 33, wherein a portion of the first optical waveguide has a cross-sectional geometry having a generally polygonal shape.
